(19) United States
(12) Patent Application Publication
(10) Pub. No.: US 2025/0233473 A1
(43) Pub. Date: Jul. 17, 2025

(54) BUSBAR ASSEMBLY, INVERTER DEVICE AND ELECTRIC DRIVE FOR DRIVING A VEHICLE

(71) Applicant: Valeo eAutomotive Germany GmbH, Erlangen (DE)

(72) Inventors: Ishwar LONDHE, Erlangen (DE); Selvakumar PRAKASH, Chennai (IN); Oliver DEHM, Erlangen (DE); Aravindan GUNASEKARAN, Chennai (IN); Bernd FELBER, Erlangen (DE); Michael HECHT, Erlangen (DE); Siddhartha SELVARAJAN, Chennai (IN)

(73) Assignee: Valeo eAutomotive Germany GmbH, Erlangen (DE)

(21) Appl. No.: 19/022,037

(22) Filed: Jan. 15, 2025

(30) Foreign Application Priority Data
Jan. 15, 2024 (DE) 102024101091.6

(51) Int. Cl. H02K 3/50; B60L 15/00; B60L 50/51; H02K 11/33; H02M 7/00

(52) U.S. Cl. CPC H02K 3/50; B60L 50/51; H02K 11/33; H02M 7/003; B60L 15/007; H02K 2203/09; H02K 2211/03

(57) ABSTRACT

A busbar assembly includes at least two busbars each having a current flow direction and a cross-sectional area with regard to the current flow direction, the cross-sectional area having opposing first and second long sides and two opposing small sides, each busbar having a through-hole extending from the first long side to the second long side. An insulating body surrounding the long sides and the small sides of each busbar along a part of the current flow direction and forming an opening for each busbar on the first long side so as to allow access to the through-hole. The insulating body forms a collar extending away from the first long side and surrounding the openings.

The present invention relates to a busbar assembly. Aside, the invention relates to an inverter device and an electric drive for driving a vehicle.

Busbar assemblies serve to connect high-voltage components such as an inverter device and a rotating electric machine in an electric drive for driving a vehicle. It is known to provide busbar assemblies with multiple busbars surrounded partially by an insulating body so that the busbar assembly forms a single part for an assembly process. During the assembly process, the busbars are electrically and mechanically connected with the high-voltage components, e.g. by screwing the busbars. The connection can be made manually or automatically, e.g. by robot.

Due to human or machine errors, fastening the busbar may fail as the fastening means may flip away from its intended connection position. If the fastening means falls into a housing of the component, a comprehensive reassembly is required to prevent that the fastening means causes mechanical damages or electric short-circuits inside the housing.

Thus, it is an object of the invention to provide an improved, in particular safer, possibility to assemble busbars in an electric drive for a vehicle.

The above object is solved by a busbar assembly, comprising at least two busbars each having a current flow direction and a cross-sectional area with regard to the current flow direction, the cross-sectional area having opposing first and second long sides and two opposing small sides, each busbar having a through-hole extending from the first long side to the second long side; and an insulating body surrounding the long sides and the small sides of each busbar along a part of the current flow direction and forming an opening for each busbar on the first long side so as to allow access to the through-hole; wherein the insulating body forms an collar extending away from the first long side and surrounding the openings.

The busbar assembly according to the invention comprises at least two busbars and an insulating body. The busbars each have a current flow direction and a cross-sectional area with regard to the current flow direction. The cross-sectional area has opposing first and second long sides. The cross-sectional area has two opposing small sides. Each busbar has a through-hole. The through-hole extends from the first long side to the second long side.

The insulating body surrounds the long sides and the small sides of each busbar along a part of the current flow direction. The insulating body forms an opening for each busbar on the first long side so as to allow access to the through-hole. The insulating body forms a collar. The collar extends away from the first long side. The collar surrounds the openings.

The invention is based upon the consideration to use the insulating body additionally for the prevention of loosing a fastening means, e.g. a screw, during assembling the busbar assembly to another electric component. For this purpose, the collar forms a physical limitation around the openings of the insulating body which limitation prevents that the fastening means departs from the busbar assembly unintentionally.

As an advantage of the invention, the busbar assembly allows to assemble the busbar assembly more safely because, in the case of a human or machine error, the fastening means remains at a controlled position. In particular, this prevents a reassembly for removing the lost fastening means. Thereby, manufacturing times and costs can be reduced in the case of an error and the danger of an electric shock for a human worker, who performs the reassembly, can be avoided.

The busbars are typically made of metal, e.g. copper. Preferably, each busbar is configured to carry a current of at least 50 A, preferably at least 100 A, more preferably at least 200 A. The current flow direction is typically perpendicular to the cross-sectional area. The cross-sectional area is preferably rectangular or radiused rectangular.

The insulating body may be made of a polymer. Preferably, the insulating body is molded around the busbars.

Preferably, the collar surrounds a single clearance around the openings. Therein, the clearance may limit a common space for the busbars to prevent a fastening means from departing the busbar assembly.

Advantageously, the collar comprises first and second wall sections opposing each other with regard to the current flow direction. Therein, the first wall section may have a recess pointing towards the second wall section between each pair of adjacent openings. Particularly, for each recess of the first wall section, the second wall section has a recess pointing towards the recess of the first wall section.

The insulating body of the busbar assembly according to the invention may encapsulates a free end with respect to the current flow direction of each busbar. The free end is preferably the free end close to the though-hole of respective busbar. This free end may be referred to as first free end.

Additionally, each busbar may comprise a further through-hole extending from the first long side to the second long side and not being covered by the insulating body. The further through-hole may be close to a second free end being opposite to the first free end.

Preferably, the insulating body comprises a through-hole arranged outside the collar between each pair of adjacent busbars. The through-hole in the insulating body may serve to fasten the busbar assembly without establishing an electrical connection.

In a preferred embodiment, the busbars are arranged such that in each pair of adjacent busbars the small sides face each other. In other word, the busbars are arranged such that their respective small sides align side-by-side. Additionally or alternatively, the busbars may be arranged in a common plane.

Preferably, the busbar assembly according to the invention is provided with three busbars. This is particularly useful in applications, where the busbars carry a three-phase AC current. Of course, other numbers of busbars are possible, such as two busbars (preferred for DC applications), four busbars, five busbars or six busbars.

The above object is further solved by an inverter device, comprising an inverter housing structure having an assembly opening; an inverter circuit having two terminals being an AC terminal and a DC terminal; and a busbar assembly according to the invention; wherein the busbar assembly is connected to one of the terminals and the openings of the insulating body are positioned to allows access to the though-holes of the busbars through the assembly opening.

The inverter circuit may comprise multiple semiconductor switching elements, e.g., IGBTs or MOSFETs, connected in half-bridges between the DC terminal and the AC terminal.

The inverter device may further comprise fastening means, in particular screws. Each fastening means may have a shaft and a head and each extending through one of the thorough-holes, the collar and the assembly opening forming a gap therebetween, the gap being smaller than a diameter of the head.

Further, the inverter device may comprise a printed circuit board, the collar being arranged between the assembly opening and the printed circuit board. Due to the protective function of the busbar assembly having the collar, a printed circuit board can be arranged safely close to the busbar. The printed circuit board may mount control electronics for the inverter circuit.

Preferably, the busbar assembly is connected to the AC terminal.

The above object is further solved by an electric drive for driving a vehicle, the electric drive comprising: a housing with a machine housing structure; an inverter device according to the invention; and a rotating electric machine arranged inside the machine housing structure; wherein the inverter housing structure forms part of the housing of the electric drive, wherein the inverter device is configured to supply the electric machine with a multiphase AC voltage via the AC terminal.

The electric machine may be a permanent magnet synchronous motor or an electrically excited synchronous motor. Alternatively, the electric machine may be an induction motor.

The above object is further solved by a vehicle, comprising an electric drive according to the invention configured to drive the vehicle.

The vehicle may be a battery electric vehicle (BEV) or a fuel-cell vehicle. Alternatively, the vehicle is a hybrid vehicle with an additional combustion engine.

Further details and advantages of the invention are disclosed in the following, wherein reference is made to the drawings. The drawings show schematically:

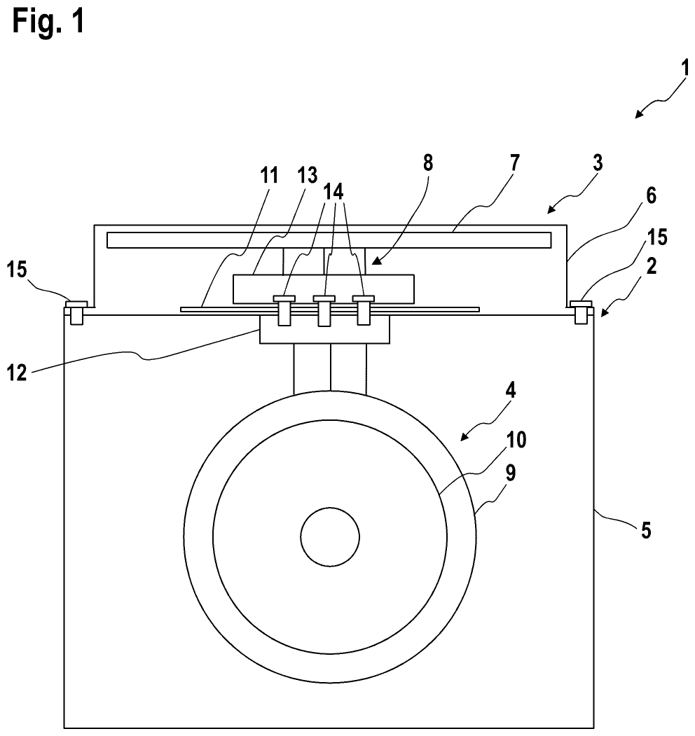

FIG. 1 a principle drawing of an embodiment of an electric drive according to the invention;

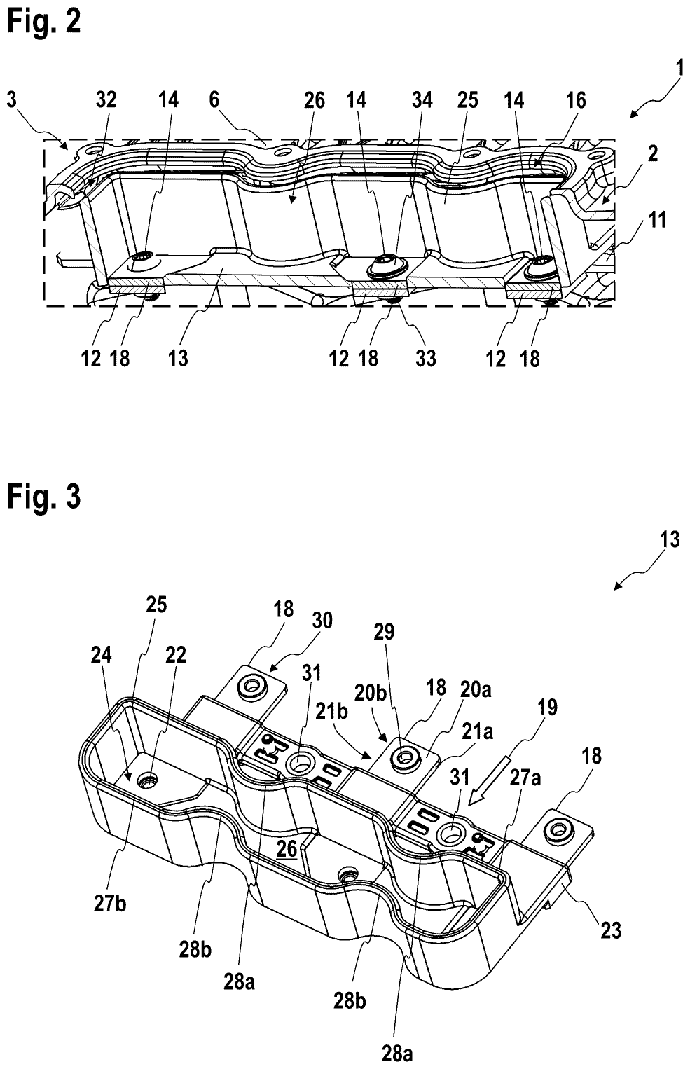

FIG. 2 a partial cross-sectional view of the embodiment of the electric drive;

FIG. 3 a perspective view of an embodiment of the busbar assembly;

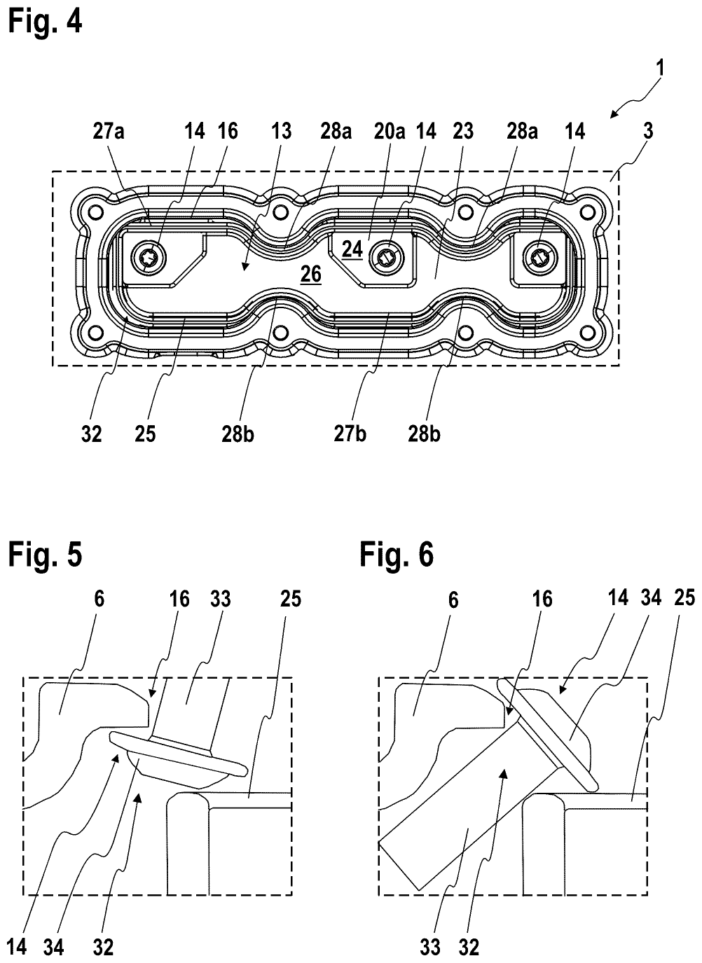

FIG. 4 a partial top view of the embodiment of electric drive showing the embodiment in a mounted state;

FIGS. 5 and 6 each a partial cross-sectional view of the embodiment of the electric drive with a loose screw; and

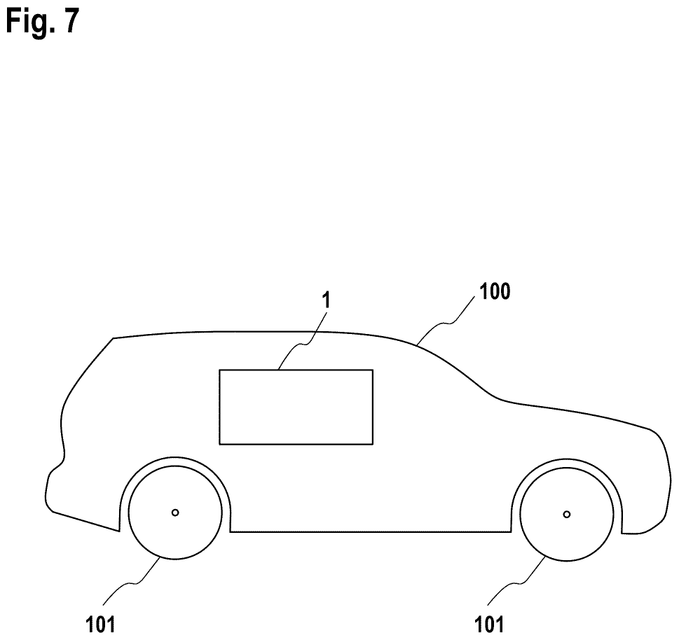

FIG. 7 a principle drawing of an embodiment of a vehicle according to the invention.

FIG. 1 is a principle drawing of an embodiment of an electric drive device 1.

The electric drive 1 comprises a housing 2, an embodiment of an inverter device 3 and a rotating electric machine 4. The housing 2 comprises a machine housing structure 5, inside which the electric machine 4 is arranged, and an inverter housing structure 6 formed by the inverter device 3.

The inverter device 3 comprises an inverter circuit 7 having two terminals being an AC terminal 8 and a DC terminal (not shown) and is configured to supply the electric machine 4 with a three-phase AC voltage via the AC terminal 8. In particular, the electric machine 4 comprises a stator 9 and a rotor 10. Exemplarily, the electric machine 4 is a permanent magnet synchronous motor or an electrically excited synchronous motor. Alternatively, the electric machine may be an induction motor.

The inverter device 3 is configured to supply stator windings with the multiphase AC voltage. As further shown in FIG. 1, the inverter device 3 comprises a printed circuit board 11, which carries control electronics for controlling the inverter circuit 7. For connecting electric machine 4 with the inverter device 3 or with its AC terminal 8, respectively, the electric drive 1 further comprises busbars 12 connected to the electric machine 4 and disposed in the machine housing structure 5. The inverter device 3 comprises an embodiment of a busbar assembly 13, which is connected electrically and mechanically to the busbars 12 arranged in the machine housing structure 5 by fastening means 14. Exemplarily, the fastening means 14 are realized by screws.

In further detail, the inverter housing structure 6 is fastened to the machine housing structure 5 by means of multiple fastening elements 15, e.g. screws.

FIG. 2 is a partial cross-sectional view of the embodiment of the electric drive 1.

The inverter housing structure 6 has an assembly opening 16, which allows access to the busbar assembly 13. During assembly of the electric drive 1, the screws 14 for connecting the busbar assembly 13 with the busbars 12 can be applied trough the assembly opening 16. As can be further seen in FIG. 2, the busbar assembly 13 is disposed between the printed circuit board 11 and the assembly opening 16.

FIG. 3 and FIG. 4 show the embodiment of the busbar assembly 13, wherein FIG. 3 is a perspective view and FIG. 4 is a partial top view of the embodiment of electric drive 1 showing the embodiment of the busbar assembly 13 in a mounted state.

The busbar assembly 13 according to the embodiment comprises three busbars 18 each having a current flow direction 19 and a cross-sectional area perpendicular to the current flow 19 direction. The cross-sectional area has opposing first and second long sides 20a, 20b and two opposing small sides 21a, 21b, wherein the second long side 20b and the second small side 21b are hidden in FIG. 3. In the present embodiment, the busbars 18 are exemplarily arranged in a common plane such that the small sides 21a, 21b face each other.

Each busbar 18 has a through-hole 22, which is partially visible in FIG. 3 and hidden by the screws 14 in FIG. 4. The through-hole 22 extends from the first long side 20a to the second long side 20b.

Further, each busbar 18 comprises an insulating body 23 surrounding the long sides 20a, 20b and the small sides 21a, 21b of each busbar 18 along a part of the current flow direction 19. The insulating body 23 forms an opening 24 for each busbar 18 on the first long side 20a so as to allow access to the through-hole 22. Further, the insulating body 23 forms a collar 25 extending away from the first long side 20a and surrounding the openings 24.

In detail, the collar 25 surrounds a single clearance 26 around the openings 24 and comprises a first wall section 27a and a second wall section 27b opposing each other with regard to the current flow direction 19. The first wall section 27a has a recess 28a pointing towards the second wall section 27b between each pair of adjacent openings 24. Likewise, the second wall section 27b has a recess 28b pointing towards the recesses 28a between each pair of adjacent openings 24.

In further detail, the insulating body 23 encapsulates a first free end (hidden by the insulating body 23 in FIGS. 3 and 4) with respect to the current flow direction 19 of each busbar 18. Each busbar 18 comprises a further through-hole 29 extending from the first long side 20a to the second long side 20b and not being covered by the insulating body 23. The through-hole 29 is arranged at a second free end 30 opposite to the first one. The through-hole 29 serves for connecting the busbar assembly 13 with the AC terminal 8 of the inverter device 3 (see FIG. 1).

Moreover, the insulating body 23 comprises a through-hole 31 arranged outside the collar 25 between each pair of adjacent busbars 18. The through-holes 31 serve for fastening the busbar assembly 13 inside the inverter housing structure 6 (see FIG. 1).

As can be seen best in FIG. 2 and FIG. 4, the openings 24 of the insulating body 23 are positioned to allows access to the though-holes 22 of the busbars 18 through the assembly opening 16. In particular, the shape of the assembly opening 16 corresponds to shape of the collar 25. Therein, a gap 32 is formed between the collar 25 and the assembly opening 16.

FIG. 5 and FIG. 6 each a partial cross-sectional view of the embodiment of the electric drive 1 with a loose screw 14.

The screws 14 each have a shaft 33 and a head 34. The gap 32 between the collar 25 and the assembly opening 16 is smaller than a diameter of the screw 14 head 34 so as to prevent the screw 14 from falling into the housing 2 during assembly. In particular, it can be avoided that the screw 14 gets in contact with the printed circuit board 11 (see FIG. 2), where it might damage electric components or cause a short-circuit.

FIG. 7 is a principle drawing of an embodiment of a vehicle 100.

The vehicle 100 comprises an electric drive 1 according to the above embodiment. The electric drive 1 is configured to propel the vehicle 100. The vehicle 100 comprises wheels 101 being directly or indirectly, e.g., via a transmission, coupled with the electric drive 1 so as to rotate the wheels 103. According to the embodiment, the vehicle 100 is a battery electric vehicle (BEV). Alternatively, the vehicle 100 may additionally comprise a combustion engine, therein forming a hybrid vehicle. Further, the electric vehicle 100 may comprise a fuel cell supplying electric drive 1.

1. Busbar assembly, comprising
at least two busbars each having a current flow direction and a cross-sectional area with regard to the current flow direction, the cross-sectional area having opposing first and second long sides and two opposing small sides, each busbar having a through-hole extending from the first long side to the second long side; and
an insulating body surrounding the long sides and the small sides of each busbar along a part of the current flow direction and forming an opening for each busbar on the first long side so as to allow access to the through-hole;
wherein the insulating body forms a collar extending away from the first long side and surrounding the openings.

2. Busbar assembly according to claim 1, wherein
the collar surrounds a single clearance around the openings.

3. Busbar assembly according to claim 1, wherein
the collar comprises first and second wall sections opposing each other with regard to the current flow direction, the first wall section having a recess pointing towards the second wall section between each pair of adjacent openings.

4. Busbar assembly according to claim 3, wherein
for each recess of the first wall section, the second wall section has a recess pointing towards the recess of the first wall section.

5. Busbar assembly according to claim 1, wherein
the insulating body encapsulates a free end with respect to the current flow direction of each busbar.

6. Busbar assembly according to claim 1, wherein
each busbar comprises a further through-hole extending from the first long side to the second long side and not being covered by the insulating body.

7. Busbar assembly according to claim 1, wherein
the insulating body comprises a though-hole arranged outside the collar between each pair of adjacent busbars.

8. Busbar assembly according to claim 1, wherein
the busbars are arranged such that in each pair of adjacent busbars the small sides face each other.

9. Busbar assembly according to claim 1, wherein
the busbar assembly with provided with three busbars.

10. Inverter device, comprising
an inverter housing structure having an assembly opening;
an inverter circuit having two terminals being an AC terminal and a DC terminal; and
a busbar assembly according to claim 1;
wherein the busbar assembly is connected to one of the terminals and the openings of the insulating body are positioned to allows access to the though-holes of the busbars through the assembly opening.

11. Inverter device according to claim 10, further comprising
fastening means, in particular screws, each having a shaft and a head and each extending through one of the thorough-holes, the collar and the assembly opening forming a gap therebetween, the gap being smaller than a diameter of the head.

12. Inverter device according to claim 10, further comprising
a printed circuit board, the collar being arranged between the assembly opening and the printed circuit board.

13. Inverter device according to claim 10, wherein
the busbar assembly is connected to the AC terminal.

14. Electric drive for driving a vehicle, the electric drive comprising:
a housing with a machine housing structure;
an inverter device according to claim 10; and
a rotating electric machine arranged inside the machine housing structure;
wherein the inverter housing structure forms part of the housing of the electric drive, wherein the inverter device is configured to supply the electric machine with a multiphase AC voltage via the AC terminal.

15. Vehicle, comprising an electric drive according to claim 14 configured to drive the vehicle.

16. Busbar assembly according to claim 2, wherein
the collar comprises first and second wall sections opposing each other with regard to the current flow direction, the first wall section having a recess pointing towards the second wall section between each pair of adjacent openings.

17. Busbar assembly according to claim 2, wherein
the insulating body encapsulates a free end with respect to the current flow direction of each busbar.

18. Busbar assembly according to claim 2, wherein
each busbar comprises a further through-hole extending from the first long side to the second long side and not being covered by the insulating body.

19. Busbar assembly according to claim 2 wherein
the insulating body comprises a though-hole arranged outside the collar between each pair of adjacent busbars.

20. Busbar assembly according to claim 2, wherein
the busbars are arranged such that in each pair of adjacent busbars the small sides face each other.
